(19) United States
(12) Patent Application Publication
(10) Pub. No.: US 2015/0318657 A1
(43) Pub. Date: Nov. 5, 2015

(54) LASER OSCILLATOR HAVING MECHANISM FOR CORRECTING DISTORTION

(71) Applicant: FANUC CORPORATION, Minamitsuru-gun (JP)

(72) Inventors: Takafumi Murakami, Minamitsuru-gun (JP); Michinori Maeda, Minamitsuru-gun (JP)

(73) Assignee: FANUC CORPORATION, Minamitsuru-gun (JP)

(21) Appl. No.: 14/700,897

(22) Filed: Apr. 30, 2015

(30) Foreign Application Priority Data
May 2, 2014 (JP) 2014-095372

(51) Int. Cl. H01S 3/03; F21V 21/14

(52) U.S. Cl. CPC H01S 3/03; F21V 21/14

(57) ABSTRACT

A laser oscillator having a mechanism which makes it easy to correct distortion in the laser oscillator, and also has a simple structure. The laser oscillator has a housing located on an installation surface and a resonator held by the housing. The resonator has a total reflecting mirror, an outputting mirror, a discharge tube positioned between the mirrors, and a laser power source which injects excitation energy into the laser medium such as the carbon dioxide gas within the discharge tube. The resonator is held on the housing by means of a holding mechanism, such as a clamp, a bolt or a bearing. The laser oscillator has at least three nonextendable legs having a constant height, and at least one extendable leg having an adjustable height, so that the legs extend from a lower part of the housing.

### BACKGROUND OF THE INVENTION

1. Field of the Invention

The present invention relates to a laser oscillator having a mechanism for correcting a structural distortion.

2. Description of the Related Art

In a laser oscillator used in a laser processing machine, etc., a beam axis of an output laser beam may be misaligned due to various factors. Therefore, it may be necessary for the laser oscillator to have an adjustment means for adjusting the misalignment. For example, JP 2002-151778 A discloses a laser oscillator having a mechanism for fixing an outputting mirror and for adjusting an angle of a reflecting mirror.

In manufacturing a laser processing machine, when flatness is different between a housing of a laser oscillator and a pedestal on which the laser oscillator is mounted, the housing having relatively low stiffness may be distorted so as to follow the shape of the pedestal, by strongly fastening the housing to the pedestal. Therefore, a beam axis of an optical system (or the oscillator), which has been adjusted at the time of manufacturing the oscillator, may be misaligned. In this case, since the optical system (or the oscillator) is distorted, it may be difficult to restore the beam axis to its original condition, only by adjusting an angle of a mirror of the oscillator after mounting it on the laser processing machine. On the other hand, it is costly to increase the stiffness of the laser oscillator so as to improve the flatness thereof.

When the pedestal on which the laser oscillator is mounted is installed, the stiffness or the flatness of a floor on which the pedestal is installed is not always uniform. Therefore, it is necessary to perform level adjustment before installing the pedestal. As a result, the flatness of the pedestal may be uneven depending on installation conditions. In the prior art, as described in JP 2002-151778 A, it is necessary to correct the misalignment of the optical system (or the oscillator) due to the unevenness of flatness of the pedestal, by adjusting an angle of a mirror, which is troublesome.

FIG. 8 shows a schematic configuration of a conventional laser oscillator 100. A housing 104 of laser oscillator 100, which is installed on an installation surface 102, has a plurality of legs 106. Each leg 106 is nonextendable, i.e., the length of each leg cannot be adjusted. For example, when a portion of installation surface 102 bulges as shown in FIG. 9a, or when a portion of installation surface 102 dents as shown in FIG. 9b, housing 104 is distorted depending on the shape of installation surface 102. As a result, a resonator 108 held by housing 104 may also be distorted, whereby components in resonator 108, such as mirrors, may be misaligned.

Further, as shown in FIG. 10, even when installation surface 102 is flat, housing 104 may be distorted when the lengths of nonextendable legs are uneven. In the prior art, in such a case, the misalignment of the beam axis due to the distortion of the housing is corrected by adjusting the angle of the mirror. However, it is troublesome to adjust the angle of the mirror, and the adjustment of the mirror angle may be insufficient for correcting the misalignment. In addition, in FIGS. 8 to 10, the scale in the height direction has been enlarged for clarity.

### SUMMARY OF THE INVENTION

An object of the present invention is to provide a laser oscillator having a mechanism which makes it easy to correct distortion in the laser oscillator, and also has a simple structure.

Accordingly, the invention provides a laser oscillator comprising: at least three nonextendable legs each having a constant height; and at least one extendable leg having an adjustable height.

In a preferred embodiment, the laser oscillator comprises: an outputting mirror; a reflecting mirror; an excitation energy injecting part which injects excitation energy into a laser medium within the laser oscillator; and a holding mechanism, which holds the outputting mirror, the reflecting mirror and the excitation energy injecting part.

In a preferred embodiment, the extendable leg has a rotatable height-adjusting mechanism.

In a preferred embodiment, the extendable leg has a locking mechanism, which locks the height of the extendable leg.

In a preferred embodiment, the oscillator further comprises a height-measuring part, which measures the height of the extendable leg.

### BRIEF DESCRIPTION OF THE DRAWINGS

The above and other objects, features and advantages of the present invention will be made more apparent by the following description of the preferred embodiments thereof, with reference to the accompanying drawings, wherein:

FIG. 1 shows a schematic configuration of a laser oscillator according to a preferred embodiment of the present invention;

FIGS. 2a to 2c are schematic top views of a housing of the laser oscillator, showing examples of arrangement of a nonextendable leg and an extendable leg;

FIG. 3a is a schematic view showing a case in which an installation surface where the laser oscillator of FIG. 1 is located has a bulging portion;

FIG. 3b is a schematic view showing a case in which an installation surface where the laser oscillator of FIG. 1 is located has a dented portion;

FIG. 4 is a schematic view showing a case in which the lengths of the nonextendable legs of the laser oscillator of FIG. 1 are different;

FIG. 5 shows an example of constitution of the extendable leg of the laser oscillator of FIG. 1;

FIG. 6 shows an example in which a mechanism for avoiding a change in the height of the extendable leg is provided to the extendable leg of FIG. 5;

FIG. 7 shows an example in which a height-measuring mechanism is provided to the extendable leg of FIG. 6;

FIG. 8 shows a schematic configuration of a laser oscillator according to the prior art;

FIG. 9a is a schematic view showing a case in which an installation surface where the laser oscillator of FIG. 8 is located has a bulging portion;

FIG. 9b is a schematic view showing a case in which an installation surface where the laser oscillator of FIG. 8 is located has a dented portion; and

FIG. 10 is a schematic view showing a case in which the lengths of the nonextendable legs of the laser oscillator of FIG. 8 are different.

### DETAILED DESCRIPTIONS

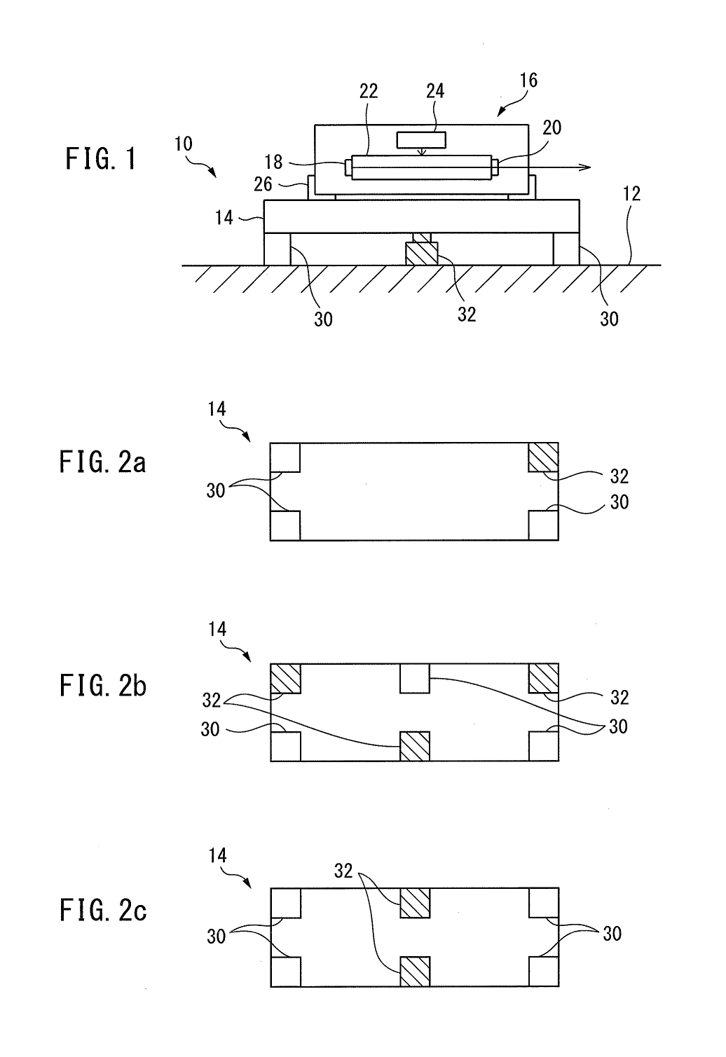

FIG. 1 shows a schematic configuration of a laser oscillator according to a preferred embodiment of the present invention. For example, laser oscillator 10 is a gas laser oscillator using carbon dioxide gas as a laser medium, and has a housing 14 located on an installation surface 12 and a resonator 16 held by housing 14. Resonator 16 may be conventional, and has a total reflecting mirror 18, an outputting mirror 20, a discharge tube 22 positioned between total reflecting mirror 18 and outputting mirror 20, and an energy injecting part (for example, a laser power source) 24 which injects excitation energy into the laser medium such as the carbon dioxide gas within discharge tube 22. Resonator 16 is held on housing 14 by means of a holding mechanism 26, such as a clamp, a bolt or a bearing. Laser oscillator 10 outputs a laser beam, and the laser beam is used for laser processing, for example. Therefore, laser oscillator 10 may be used as a laser processing machine. Although laser power source 24 is incorporated in resonator 16 in FIG. 1, laser power source 24 may be positioned outside resonator 16.

Laser oscillator 10 has at least three nonextendable legs 30 having a constant height (length), and at least one extendable leg 32 having an adjustable height (length), so that the legs extend from a lower part of housing 14. For example, as shown in FIG. 2a schematically showing housing 14 viewed from the above, when hosing 14 has a generally rectangular shape in a planar view, and when the legs should be positioned at four corners of the rectangle, three nonextendable legs 30 may be positioned at the three corners, and one extendable leg 32 may be positioned at the remaining one corner.

Alternatively, as shown in FIG. 2b, when hosing 14 has a generally rectangular shape in a planar view, and when the legs should be positioned at four corners of the rectangle and at two generally intermediate positions of two long sides of the rectangle (i.e., six legs are used), three nonextendable legs 30 may be positioned at both ends of one long side and the intermediate position of the other long side, and three extendable legs 32 may be positioned at the remaining three positions.

Alternatively, as shown in FIG. 2c, when hosing 14 has a generally rectangular shape in a planar view, and when the legs should be positioned at four corners of the rectangle and at two generally intermediate positions of two long sides of the rectangle (i.e., six legs are used), four nonextendable legs 30 may be positioned at the four corners of the rectangle, and two extendable legs 32 may be positioned at the remaining two positions (intermediate positions).

As described above, a portion of housing 14, where nonextendable leg 30 and extendable leg 32 should be positioned, may be selected depending on the shapes of housing 14 and the installation surface of the laser oscillator. In this regard, it is preferable that all of the nonextendable legs are not aligned in a straight line in the planar view (i.e., one plane is defined by three nonextendable legs).

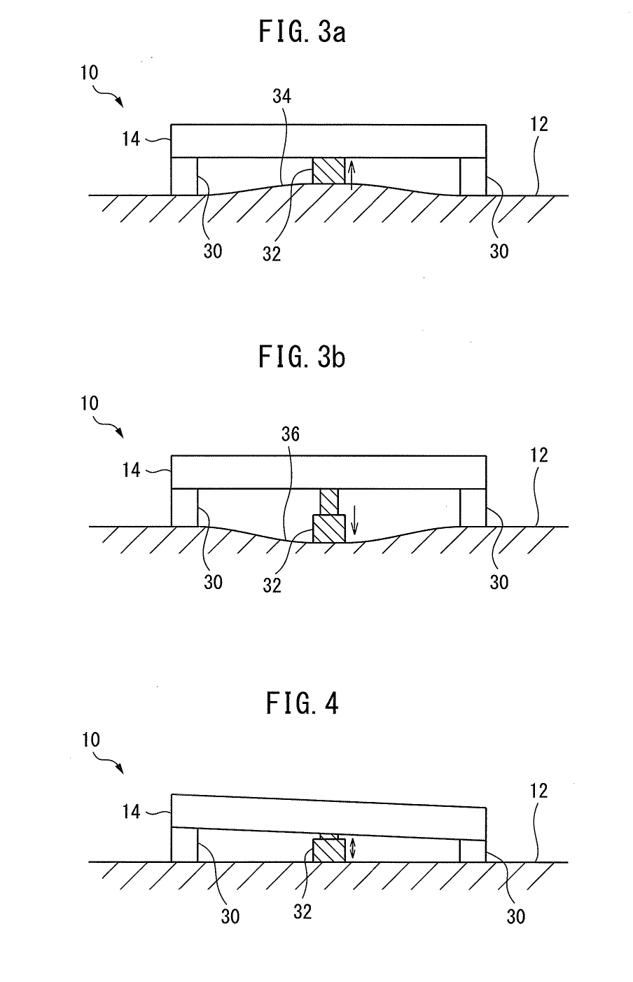

FIG. 3a is a schematic view of laser oscillator 10 of FIG. 1, viewed from a lateral side thereof, in which installation surface 12 has a bulging portion 34. After laser oscillator 10 is located on installation surface 12 by using at least three nonextendable legs 30, the height of extendable leg 32 is adjusted so that an installation surface contacting portion of extendable leg 32 (as explained below) comes into contact with bulging portion 34. By virtue of this, housing 14 is not distorted or deflected, whereby resonator 16 held by housing 14 is not adversely affected. Therefore, it is not necessary to carry out a troublesome operation, such as adjustment of the angle of the mirror, etc. In addition, even when the resonator is deformed corresponding to the deformation of housing 14, the resonator may be restored to its original status in which a beam axis is appropriately adjusted, by adjusting the length of extendable leg 32. Therefore, it is not necessary to shift the laser oscillator, or to adjust the position of the mirror in the laser oscillator each time the laser oscillator is installed.

FIG. 3b is a schematic view of laser oscillator 10 of FIG. 1, viewed from a lateral side thereof, in which installation surface 12 has a dented portion 36. After laser oscillator 10 is located on installation surface 12 by using at least three nonextendable legs 30, the height of extendable leg 32 is adjusted so that the installation surface contacting portion of extendable leg 32 (as explained below) comes into contact with dented portion 36. By virtue of this, similarly to the example of FIG. 3a, housing 14 is not distorted or deflected, whereby resonator 16 held by housing 14 is not adversely affected. Therefore, it is not necessary to adjust the angle of the mirror, etc., which is troublesome. In addition, even when the resonator is affected by the deformation of housing 14, the affect may be eliminated by adjusting the length of extendable leg 32.

FIG. 4 shows an example in which at least two nonextendable legs 30 have the different length (height), whereas installation surface 12, where laser oscillator 10 is located, is a flat surface having no bulging or dented portion. Also in this case, by appropriately adjusting the height of extendable leg 32 (in the illustrated embodiment, by adjusting the height of extendable leg 32 positioned between two nonextendable legs 30 having the different heights so that the height of extendable leg 32 corresponds to an average height of the two nonextendable legs), housing 14 is not distorted or deflected, whereby the distortion of resonator 16 or the misalignment in resonator 16 can be avoided. In addition, in FIGS. 3a to 4, the scale in the height direction has been enlarged for clarity, and resonator is omitted.

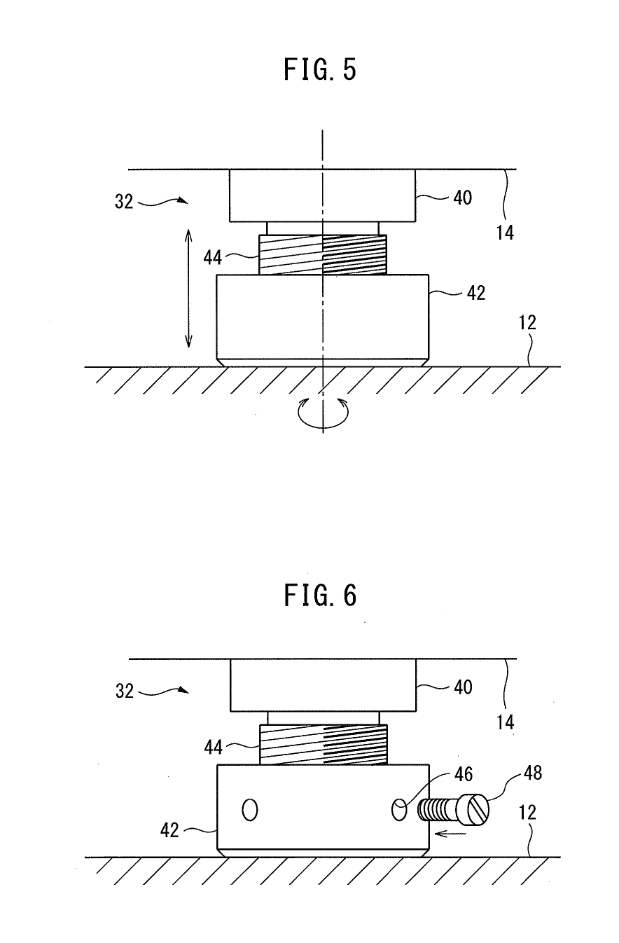

FIG. 5 shows a concrete configuration example of extendable leg 32. Extendable leg 32 has a base portion 40 attached to the lower part of laser oscillator 10 (e.g., the lower surface of housing 14), and an installation surface contacting portion 42 displaceable relative to base portion 40 in the height direction and configured to contact installation surface 12. In the illustrated embodiment, installation surface contacting portion 42 has a female screw (not shown) threadably engaged with a male screw 44 integrally formed with base portion 40. By rotating installation surface contacting portion 42 relative to base portion 40, the length (or the height) of extendable leg 32 can be adjusted. Although the mechanism for changing the length of extendable leg 32 is not limited as such, the length of extendable leg 32 may be accurately adjusted in a micrometer order, by using the rotatable height-adjusting mechanism as shown in FIG. 5.

As shown in FIG. 6, extendable leg 32 may have a mechanism for avoiding an unintended change in the adjusted height of extendable leg 32. For example, an internal thread 46 is formed in installation surface contacting portion 42 of extendable leg 32, and a locking screw 48 is threadably engaged with internal thread 46 so that a front end of locking screw 48 comes into contact with male screw 44. By virtue of this, the rotation of installation surface contacting portion 42 relative to base portion 40 (i.e., the change in the height of extendable leg 32) can be avoided. Otherwise, extendable leg 32 may be covered by a cap or the like (not shown) so that the rotation of installation surface contacting portion 42 relative to base portion 40 is avoided by such a more simple structure.

By using the mechanism for avoiding the change in the height of extendable leg 32 as shown in FIG. 6, an unintended change in the height of extendable leg 32 can be avoided. Further, when the laser oscillator is shifted or conveyed from one pedestal to the other pedestal having the same degree of flatness as the former pedestal, it is not necessary to readjust the height of extendable leg 32.

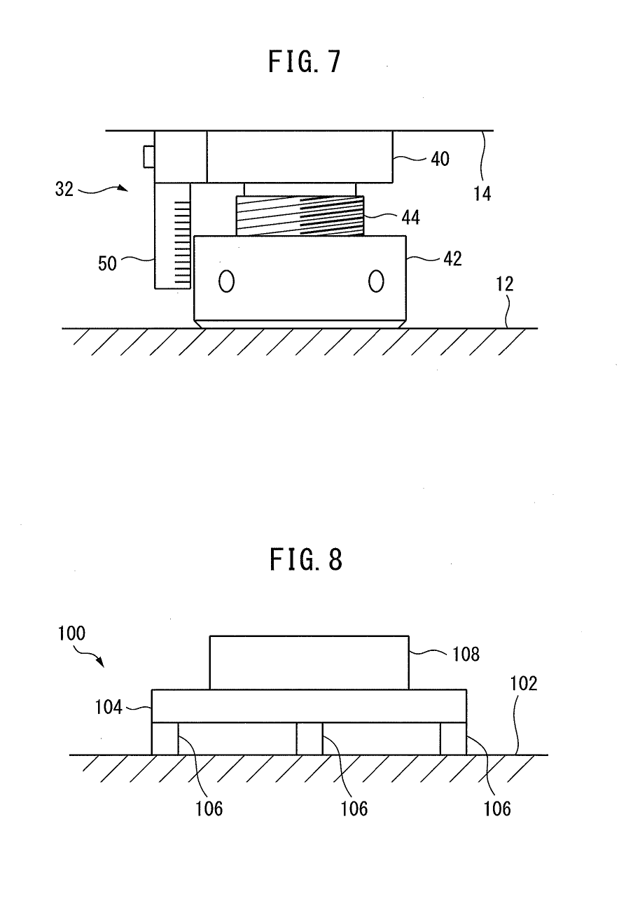

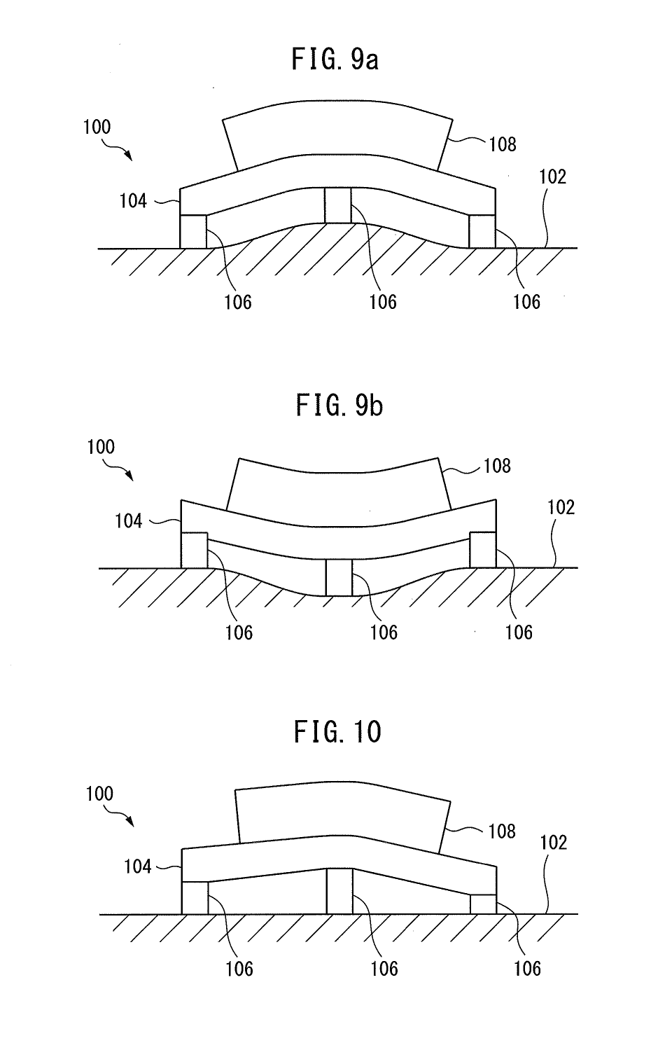

Further, as shown in FIG. 7, extendable leg 32 may have a height-measuring part which measures the adjusted height of extendable leg 32. For example, by attaching a graduated scale 50 to base portion 40 of extendable leg 32, the operator can easily recognize the current height of extendable leg 32, and can quantitatively adjust the height thereof. Alternatively, a distance sensor may be used as the height-measuring part.

According to the present invention, the height of the extendable leg can be adjusted corresponding to the projection or recess on the installation surface of the laser oscillator. Therefore, the distortion in the laser oscillator is avoided, and it is not necessary to adjust the position or angle of the mirror in the laser oscillator. Even when the resonator is deformed depending on the deformation of the housing of the laser oscillator, the resonator can be restored to its original condition in which the beam axis is aligned, by adjusting the length of the extendable leg. Therefore, it is not necessary to adjust the position of the mirror in the laser oscillator each time the laser oscillator is shifted or installed.

By using the rotatable height-adjusting mechanism, the height of the extendable leg can be accurately adjusted in a micrometer order. Further, by using the locking mechanism for locking the height-adjusting mechanism, an unintended change in the height of the extendable leg can be avoided.

When the laser oscillator is relocated from one pedestal to the other pedestal having the same degree of flatness as the former pedestal, it is not necessary to readjust the height of the extendable leg. Further, by using the height-measuring part for the extendable leg, it is facilitated to quantitatively recognize or determine the current height of the extendable leg 32, or an amount of adjustment by which the height of the extendable leg should be adjusted.

While the invention has been described with reference to specific embodiments chosen for the purpose of illustration, it should be apparent that numerous modifications could be made thereto, by one skilled in the art, without departing from the basic concept and scope of the invention.

1. A laser oscillator comprising:
at least three nonextendable legs each having a constant height; and
at least one extendable leg having an adjustable height.

2. The laser oscillator as set forth in claim 1, wherein the laser oscillator comprises:
an outputting mirror;
a reflecting mirror;
an excitation energy injecting part, which injects excitation energy into a laser medium within the laser oscillator; and
a holding mechanism, which holds the outputting mirror, the reflecting mirror and the excitation energy injecting part.

3. The laser oscillator as set forth in claim 1, wherein the extendable leg has a rotatable height-adjusting mechanism.

4. The laser oscillator as set forth in claim 1, wherein the extendable leg has a locking mechanism, which locks the height of the extendable leg.

5. The laser oscillator as set forth in claim 1, wherein the oscillator further comprises a height-measuring part, which measures the height of the extendable leg.
